(19) United States
(12) Patent Application Publication
(10) Pub. No.: US 2018/0089775 A1
(43) Pub. Date: Mar. 29, 2018

(54) Database Relating To Devices Installed In A Building Or Area

(71) Applicant: Siemens Schweiz AG, Zuerich (CH)

(72) Inventors: Christian Frey, Unteraegeri (CH); Oliver Zechlin, Zug (CH)

(73) Assignee: Siemens Schweiz AG, Zuerich (CH)

(21) Appl. No.: 15/714,695

(22) Filed: Sep. 25, 2017

(30) Foreign Application Priority Data
Sep. 27, 2016 (DE) 10 2016 218 537.3

(51) Int. Cl. G06Q 50/16; H04N 7/18; G06F 17/30; G06Q 10/08

(52) U.S. Cl. CPC G06Q 50/163; H04N 7/185; H04L 67/1097; G06Q 10/087; G06F 17/30377

(57) ABSTRACT

The present disclosure relates to databases. The teachings thereof may be embodied in methods and databases with data from devices installed in a building and/or with data from devices installed on a site. For example, a method for maintaining a database with data associate with a plurality of devices present at a site may include: establishing a connection to a Web service via a software program installed on a mobile communication terminal; sending data acquired by a user using the mobile communication terminal to the Web service; and entering the data received from the mobile communication terminal into the database by a corresponding database entry.

### CROSS-REFERENCE TO RELATED APPLICATIONS

This application claims priority to DE Application No. 10 2016 218 537.3 filed Sep. 27, 2016, the contents of which are hereby incorporated by reference in their entirety.

### TECHNICAL FIELD

The present disclosure relates to databases. The teachings thereof may be embodied in methods and databases with data from devices installed in a building and/or with data from devices installed on a site.

### BACKGROUND

Collections of data about devices or systems installed in buildings, on a campus, or at a customer are often incomplete and not up-to-date. Furthermore, such collections, sometimes called an iBase (Installed Base), may not be recorded electronically or only recorded electronically in less than all aspects. In such cases recorded electronically can mean: In text form, with videos or photos, with links to Web sites, etc.

In the event of a system defect, identifying the amount of damage, or to which part of the system or the installation in the field the damages occurred is often not clear. A remote diagnosis based on a description of the fault can also be problematic, since often only incomplete data is present about type, variant, and/or service intervals. In more recent times, with new installations, some of the installed systems have been recorded in a database after completion and handover of the installation to the customer. But information about an installed base in an area, a building, or at a customer can also be taken from ERP (Enterprise Resource Planning; e.g. SAP) systems to some extent.

Specific parts of an installation may be subject to regular visual checks to comply with safety protocols, such as for example for the presence of the device (fire alarms in buildings), the dynamic function of a device (illumination of the emergency exit sign, flashing of a control LED, showing information on a display), fill level of a component (fire extinguisher), unobstructed escape routes, etc. For such a visual check, persons are sent to the site, to obtain a picture, which is then documented in writing in an inspection log (e.g. by ticking off items in a checklist or text). In such cases, however, it cannot be independently ensured that the person was actually on site and/or whether the inspection was carried out correctly. Such subjective visual checks are also a cause of an installed base being incomplete or not being up-to-date.

### SUMMARY

The teachings of the present disclosure may provide a method and an arrangement for maintaining an installed base that is as complete and up-to-date as possible in a simple and efficient way. For example, a method for creating and/or for maintaining a database (DB) with data from devices (FG1-FG3, BM1, BM2, L1, L2, C1, C2) installed in a building (GB1, GB2) and/or with data from devices installed on a campus or a site, may include: a connection to a Web service is established via a software program installed on a mobile communication terminal (MG1, MG2); data (GD) acquired by a user (B1, B2) using the mobile communication terminal (MG1, MG2), in particular one or more photographs or video recordings of a device installed in the building (GB1, GB2) or on the site, is sent to the Web service (WS); and the Web service (WS) enters the data received from the mobile communication terminal (MG1, MG2) into the database (DB) by a corresponding database entry.

In some embodiments, the user (B1, B2) is instructed by the Web service via the mobile communication terminal (MG1, MG2) to take one or more photographs or to make one or more video recordings of a specific device (FG1-FG3, BM1, BM2, L1, L2, C1, C2) and transmit them to the Web service (WS).

In some embodiments, the user (B1, B2) is instructed by a mini job (MA) via the mobile communication terminal (MG1, MG2) to take one or more photographs or to make one or more video recordings of a specific device (FG1-FG3, BM1, BM2, L1, L2, C1, C2) and transmit them to the Web service (WS).

In some embodiments, based on the local position of the mobile communication terminal (MG1, MG2), the user (B1, B2) of the mobile communication terminal (MG1, MG2) is instructed by the Web service (WS) to take one or more photographs or to make one or more video recordings of one or more devices located in the environment of the mobile communication terminal (MG1, MG2) and transmit them to the Web service (WS).

In some embodiments, the method is used for visually checking devices, in particular fire or smoke detectors (BM1, BM2).

In some embodiments, the data sent to the Web server (VE) comprises text and/or an image and/or a video and/or audio information and/or a time of day and/or location data and/or sensor information.

Some embodiments may include an arrangement for carrying out a method as described above.

As another example, an arrangement for creating and/or for maintaining a database (DB) with data from devices installed in a building (GB1, GB2) and/or with data from devices installed on a site, may include: a mobile communication terminal (MG1, MG2) with a corresponding software program for providing a connection to a Web service (WS); and a server (VE), on which the Web service (WS) and the database (DB) with the data of the installed devices are implemented. Data acquired by a user (B1, B2) using the mobile communication terminal (MG1, MG2), in particular one or more photographs or video recordings of a device installed in the building (GB1, GB2) or on the site, is able to be sent to the Web service (WS). The Web service (WS) enters the data received from the mobile communication terminal (MG1, MG2) into the database (DB) by a corresponding database entry.

In some embodiments, there is a facility for determining the location of the mobile communication terminal (MG1, MG2), wherein, based on the local position of the mobile communication terminal (MG1, MG2), the user (B1, B2) of the mobile communication terminal (MG1, MG2) is able to be instructed by the Web service (WS) to take one or more photographs or to make one or more video recordings of one or more devices located in the environment of the mobile communication terminal (MG1, MG2) and transmit them to the Web service (WS).

In some embodiments, the mobile communication terminal (MG1, MG2) of the user (B1, B2) is configured to receive mini jobs (MA), wherein the user (B1, B2) is able to be instructed by a mini job (MA) via the mobile communication terminal (MG1, MG2) to take one or more photographs or to make one or more video recordings of a specific device (FG1-FG3, BM1, BM2, L1, L2, C1, C2) and transmit them to the Web service (WS).

### BRIEF DESCRIPTION OF THE DRAWINGS

The teachings of the present disclosure, as well as various embodiments, will be explained using the figures below as an example. In the figures:

FIG. 1 shows a first example of an arrangement for creation and/or for maintenance of a database with data from devices installed in a building and/or with data from devices installed on a site, according to teachings of the present disclosure;

FIG. 2 shows a second example of an arrangement for creation and/or for maintenance of a database with data from devices installed in a building and/or with data from devices installed on a site, according to teachings of the present disclosure; and

FIG. 3 shows an example of a flow diagram for a method for creation and/or for maintenance of a database with data from devices installed in a building and/or with data from devices installed on a site according to teachings of the present disclosure.

### DETAILED DESCRIPTION

Various methods for creating and/or for maintaining a database with data from devices installed in a building and/or with data from devices installed on a campus or a site, may include a connection to a Web service created via a software program installed on a mobile communication terminal (e.g. smartphone, tablet computer); wherein data recorded by a user using the mobile communication terminal, in particular one or more photographs or video recordings of a device installed in a building or at the site, is sent to the Web service; and wherein the Web service enters the data received from the mobile communication terminal into the database by a corresponding database entry. Such methods make possible an effective creation and maintenance of a database (iBase, installed base) with information about an infrastructure installed in a building, on a campus, or at a customer (e.g. for building automation). Inter alia, this makes possible an efficient and proactive asset management. In the event of a fault for example (e.g. fault in an installed device) a service technician can be informed as to the type of device involved and as to the tools or spare parts that are needed. This makes an efficient use of resources for maintenance and service of the iBase possible and of the installed infrastructure. In some embodiments, the method may be used for the maintenance of a data information system for management of fixed assets and/or for an efficient asset management.

In some embodiments, a software program may be installed on a mobile communication terminal (e.g. smartphone, tablet computer, notebook) such as an App (application program) for example, which is installed by an Internet download on the mobile communication terminal for example. The software program can involve processing software, which is configured to execute a called Web service. The Web service can be activated by a URL link for example and operated in a browser of the mobile communication terminal.

In some embodiments, the user may be instructed by the Web service via the mobile communication terminal to record one or more photos or videos of a specific device and to transmit them to the Web service. A user may be requested by the Web service through a push service to photograph devices of a particular manufacturer installed in a particular building and to send these photos to the Web service. The Web service may initiate a corresponding database entry of the received photos (e.g. in a relational database). In some embodiments, the user has a contractual agreement with the Web service operator. Employees (e.g. service technicians) of a manufacturer or facility manager at the customer can also be instructed to photograph all devices or specific devices of this manufacturer and to forward them to the Web service.

In some embodiments, the user may be instructed by a mini job via the mobile communication terminal to take one or more photos or video recordings of a specific device and transmit them to the Web service. The user can be logged in at a mini job marketplace (e.g. Mechanical Turk from Amazon) and receive corresponding jobs.

In some embodiments, the user of the mobile communication terminal may be instructed by the Web service to take one or more photos or make one or more video recordings, based on the local position of the mobile communication terminal, of one or more devices located in the environment of the mobile communication terminal and transmit them to the Web service. This explicitly enables users who are located with their mobile communication terminals in the vicinity of a specific building or area to be instructed to take one or more photos of infrastructure installed in these buildings or areas and transmit them to the Web service. This means that no traveling expenses are incurred for the users. The local position of the mobile communication terminals can be established by positioning systems (e.g. satellite-based systems such as GPS or by an indoor positioning system (IPS), such as e.g. iBeacons). Mobile communication terminals may be equipped with corresponding software and hardware.

Some embodiments may include visual checking of devices, e.g., fire or smoke alarms. Systems and objects that are subject to a (possibly legislation-related, regular) visual check can thus be digitally recorded. As well as an “OK” or “FALSE”, for the transmit log (for transfer to the Web service) the location data and the precise time of day can also be delivered by means of positioning (e.g. by GPS). Thus the Web service, before completion of the visual check, can request photos, videos, sound, or spoken comments from the user. Thus on the one hand the carrying out of a visual check on a specific device (object, e.g. fire alarm) can be verified and on the other hand this data also helps, in the event of problems, in better understanding said problems from a remote location. Corresponding analysis algorithms can also determine in such cases whether the correct object is involved. The data may be stored in such cases directly in a database or the Cloud and is thus available to the customer as evidence that the work has been done or also for statistical analysis.

In some embodiments, the data sent to the Web server comprises text and/or an image and/or a video and/or audio information and/or a time of day and/or location data and/or sensor information. The enhancement with further information means that the description of the situation in relation to a corresponding device becomes more exact and the database entry more comprehensive. This enables possible cases of faults on a device of the iBase (installed base) to be rectified in a more targeted manner.

In some embodiments, an arrangement carries out the methods descried. The arrangement for carrying out the method can be realized from commercially available hardware and software components.

In some embodiments, there is an arrangement for creation and/or for maintenance of a database with data from devices installed in a building and/or with data from devices installed on a campus or a site, said arrangement comprising:
A mobile communication terminal with a corresponding software program, to provide a connection to a Web service;
A server, on which the Web service and the database with the data of the installed devices are implemented;
Wherein data recorded by a user using the mobile communication terminal, in particular one or more photos, of a device installed in the building or on the campus or site and is able to be transmitted to the Web service; and
wherein the Web service enters the data received from the mobile communication terminal into the database by a corresponding database entry.

Such an arrangement may enable an effective creation and maintenance of a database (iBase, Installed Base) with information about an infrastructure installed in a building, on a campus, or at a customer (e.g. for a building automation). Inter alia this makes an efficient and proactive maintenance management possible. The arrangement may be realized with commercially available hardware and software components.

In some embodiments, the arrangement comprises a facility for determining the position of the mobile communication terminal, wherein, based on the local position of the mobile communication terminal, the user of the mobile communication terminal is able to be instructed by the Web service to take one or more photographs or make one or more video recordings of one or more devices located in the environment of the mobile communication terminal and transmit them to the Web service. This means that no traveling expenses are incurred for the user. Facilities for determining a position (positioning systems), e.g. GPS or IPS, are in widespread use and do not have to be made available as an extra. Mobile communication terminals are nowadays equipped with radio transmitters, which can be located by positioning systems. Based on this positioning data, mobile communication terminals can be instructed in a dedicated manner by the Web service.

In some embodiments, the mobile communication terminal of the user may be configured to receive mini jobs, wherein the user is able to be instructed by a mini job via the mobile communication terminal to take one or more photographs of a specific device and transmit them to the Web service. The user can be logged on for example at a mini job marketplace (e.g. Mechanical Turk from Amazon) and receive corresponding jobs.

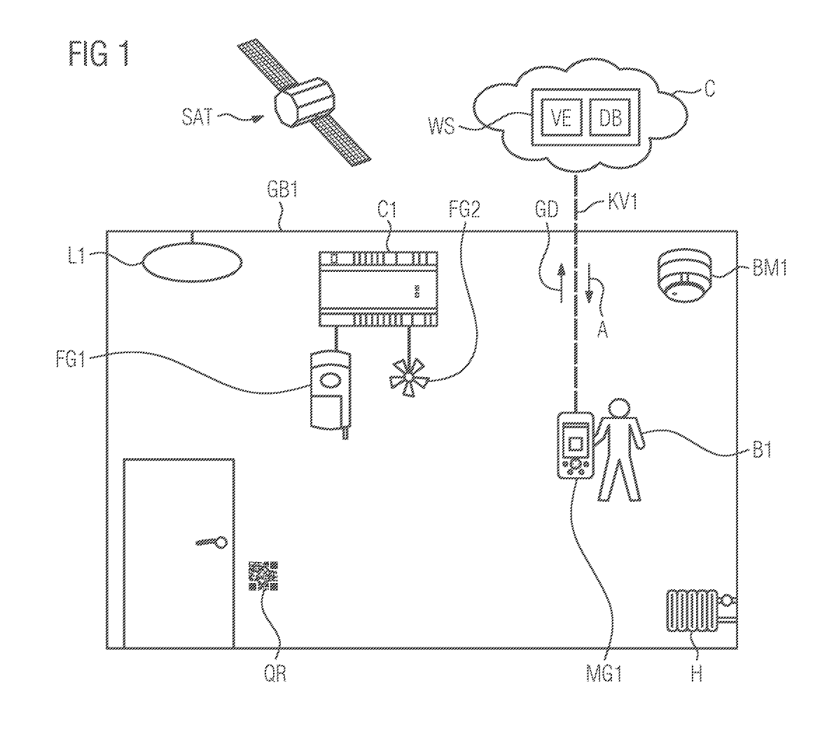

FIG. 1 shows a first example of an arrangement for creation and/or for maintenance of a database DB with data GD from devices FG1, FG2, C1, L1, BM1 installed in a building GB1 and/or with data from devices installed on a site according to teachings of the present disclosure. The arrangement may comprise a mobile communication terminal MG1 with a corresponding software program (e.g. App), in order to provide a communication link KV1 to a Web service WS; a server VE, on which the Web service WS and the database DB with the data of the installed devices FG1, FG2, C1, L1, BM1 are implemented; wherein data GD, e.g., one or more photographs of devices FG1, FG2, C1, L1, BM1 installed in the building GB1 or installed on the site recorded by a user B1 using the mobile communication terminal MG1 are able to be transmitted to the Web service WS; and wherein the Web service WS enters the data GD received from the mobile communication terminal MG1 into the database DB by a corresponding database entry. The example of the arrangement in accordance with FIG. 1 further comprises a facility SAT for determining the position of the mobile communication terminal MG1, wherein, based on the local position of the mobile communication terminal MG1, the user B1 of the mobile communication terminal MG1 is able to be instructed by the Web service WS to take one or more photographs or make one or more video recordings of one or more devices FG1, FG2, C1, L1, BM1 located in the environment of the mobile communication terminal MG1 and transmit them to the Web service WS.

In the example of the arrangement in accordance with FIG. 1, a user B1 receives a job A from the Web service WS on their mobile communication terminal MG1 (e.g. smartphone) instructing them to take photos of devices, systems or assets in the building GB1. In some embodiments, the user B1 is logged on to the Web service WS or is registered with a corresponding Internet provider or a corresponding Internet platform, so that it is known to the Web service WS that the user B1 is available for such jobs. Via the satellite positioning system SAT (e.g. GPS) it is known to the Web service WS that a corresponding user B1 is located in or in the vicinity of the building GB1. Located in building GB1 for example are a light L1, a heater H, a closed-loop and open-loop control device (e.g. controller) C1. The controller C1 regulates or controls a setting element FG1 (e.g. an actuator for blinds) and a ventilator FG2.

In some embodiments, the user B1 is instructed by the Web service WS to visually check devices in the building GB1, in particular fire or smoke detectors BM1. Systems and objects that are subject to a (possibly legislation-related, regular) visual check, can thus be digitally recorded. As well as an “OK” or “FALSE”, the location data and the precise time of day can also be delivered by means of positioning (e.g. by GPS) to the transmit log GD (for transfer to the Web service). Thus the Web service WS, before completion of the visual check, can request photos, videos, sound, or spoken comments from the user B1. On the one hand the carrying out of a visual check on a specific device (object, e.g. fire detector BM1) can be verified and on the other hand this data also helps, in the event of problems, in better understanding said problems from a remote location at a later stage.

In some embodiments, the Web service WS is realized on a Web server, with communication, storage, processing and input/output mechanisms. In the diagram depicted in FIG. 1 the Web server or Web service WS comprises a processing unit (e.g. processor) VE and a database DB. In some embodiments, the Web server or the Web service WS is realized in a Cloud. The Web server or the Web service WS can e.g. be provided as “Infrastructure as a Service” (IAAS) for a corresponding customer base. The communication link KV1 between the Web service WS and the mobile communication terminal MG1 can be via a mobile radio network (e.g. GSM, LTE) or WLAN for example.

Corresponding analysis algorithms on the processing unit VE can determine whether the visual check has been carried out for the correct object. The data GD is stored in such cases directly in a database DB or the Cloud C and is thus available to a customer (client) as evidence that the work has been done.

In some embodiments, the corresponding software program for communication with the Web service WS can be loaded onto the mobile communication terminal MG1, e.g. by a corresponding Internet download. The corresponding software program can also be loaded onto the mobile communication terminal MG1 by scanning-in a corresponding QR code. In some embodiments, the corresponding software program (e.g. App) may be loaded onto the mobile communication terminal MG1 after a request by the Web service WS.

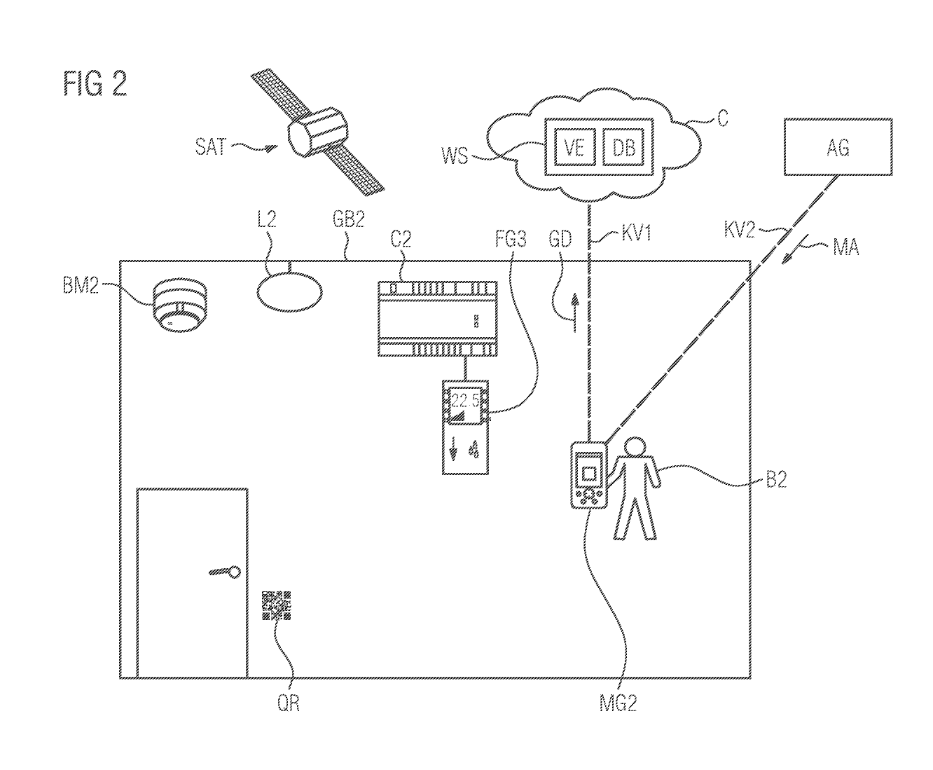

FIG. 2 shows a second example of an arrangement for creating and/or for maintaining a database DB with data from devices installed in a building GB2 and/or with data from devices installed on a site according to teachings of the present disclosure. The example of an arrangement in accordance with FIG. 2 comprises:
A mobile communication terminal MG2 with a corresponding software program for providing a connection to a Web service WS;
A server VE, on which the Web service and the database DB with the data of the installed devices are implemented.

Data GD, in particular one or more photographs of a device installed in the building GB2 or on the site, taken by a user B2 using the mobile communication terminal MG2, may be transmitted to the Web service WS. The Web service WS enters the data GD received from the mobile communication terminal MG2 into the database DB by a corresponding database entry.

The example of the arrangement in accordance with FIG. 2 furthermore comprises a facility SAT for determining the position of the mobile communication terminal MG2, wherein, based on the local position of the mobile communication terminal MG2, the user B2 of the mobile communication terminal MG2 is able to be instructed by the Web service WS to take one or more photographs of one or more devices located in the environment of the mobile communication terminal MG2 and transmit them to the Web service WS.

In some embodiments, the mobile communication terminal MG2 of the user B2 is configured to receive mini jobs MA, wherein the user B2 may be instructed by a mini job MA via the mobile communication terminal MG2 to take one or more photographs of a specific device BM2, L2, C2, FG3 and transmit them to the Web service WS. Via the satellite positioning system SAT it is known to the Web service WS that a corresponding user B2 is located in or in the vicinity of the building GB2. A light L2 and a closed-loop and open-loop control device (e.g. controller) C2 are located in the building GB2 for example. The controller C2 regulates or controls a thermostat FG3 (e.g. for climate-control and/or heating regulation). The positioning system can involve a satellite-based system (e.g. GPS) for example or an indoor positioning system IPS (e.g. based on iBeacons, BLE (Bluetooth Low Energy).

In some embodiments, the user B2 is instructed by the Web service WS to visually check devices in the building GB2, in particular fire or smoke detectors BM2. To this end the user B2 can receive from a client AB (e.g. via a mini job platform such as e.g. Mechanical Turk from Amazon) a corresponding mini job MA via the communication link KV2 on the mobile communication terminal MG2 (e.g. smartphone, tablet computer). In conjunction with the positioning system SAT, one or more users B2 who are located in the vicinity of the building or in the building GB2 can be explicitly instructed by corresponding mini jobs MA to make visual checks on devices BM2 in building GB2. This is efficient since extra service personnel do not have to be commissioned for a visual check, since no traveling time is involved for example.

In some embodiments, the Server VE, on which the Web service WS and the database DB with the data of the installed devices are implemented, is realized in a Cloud (e.g. in a networked Cloud). The communication links may involve radio for example, in particular mobile radio connections. In some embodiments, the Web service WS is connected to the job platform AG by a suitable communication link (e.g. Internet) for mutual synchronization (e.g. “job was carried out satisfactorily” or “Further visual check required”) of jobs MA.

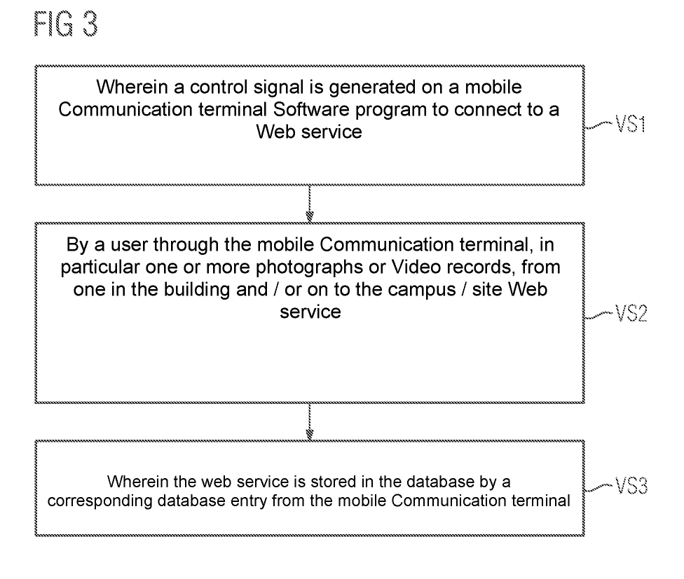

FIG. 3 shows an example of a flow diagram for a method for creating and/or for maintaining a database with data from devices installed in a building and/or with data from devices installed on a site, according to teachings of the present disclosure. A connection to a Web service is created via a software program installed on a mobile communication terminal; data recorded by a user using the mobile communication terminal, in particular one or more photographs, of a device installed in the building or on the site is sent to the Web service; and the Web service enters the data received from the mobile communication terminal into the database by a corresponding database entry.

In some embodiments, the user is instructed by the Web service via the mobile communication terminal to take one or more photographs of a specific device and transmit them to the Web service. In some embodiments, the user is instructed by a mini job via the mobile communication terminal to take one or more photographs of a specific device and to transmit them to the Web service. The mini job can e.g. originate from a mini job platform (e.g. Mechanical Turk). In some embodiments, the user, based on the local position of their mobile communication terminal, is instructed by the Web service or by the mini job platform to take one or more photographs of one or more devices located in the environment of the mobile communication terminal and transmit them to the Web service.

In some embodiments, the method for visual checking of devices, in particular fire or smoke detectors, is used. In some embodiments, the data sent to the Web server comprises text and/or an image and/or a video and/or audio information and/or a time of day and/or location data and/or sensor information. Sensor information comprises for example earth's magnetic field information, radio wave fingerprints (these two serve e.g. to determine the position), but also object-detecting sensor systems, which in mobile communication terminals detect the objects to be defined (e.g. laser scanners (generation of a point cloud), radar, ultrasound). These are sensor systems that do not generate photos in the human sense, but can generate “technical images” through their reflection characteristics. This enables explicit and/or dedicated, further measures in relation to a device to be initiated by the Web service.

The method may be realized by commercially available hardware or software components. The method can be carried out for example by an App and/or a Web service on the mobile communication terminal (e.g. smartphone or tablet computer), which is able to be called up via the mobile communication terminal (e.g. through a URL address). A service App or Web service with optional multimedia document acquisition and linkage to a control center and/or database solves the problems in a diversity of ways.

In some embodiments, the App/service all persons (crowd) can notify the presence of specific products (e.g. of a specific manufacturer or of defective device). This notification is given, together with the location and further information, by the person to an acquisition point at company x, to a database system or to an external service provider. There the data is further processed and reconciled (with the existing iBase). Thus, the iBase permanently updates itself. In some embodiments, motivation to take part can be supported by a competition for example. Thus, all employees of a company (who are also familiar with their products to some extent) on business trips, or also privately, can keep their eyes open and record and notify possible products installed by this company with an App/service.

However, all other persons (many of whom are moving around in different buildings/installations/campuses) can take part in the action. Examples of such people might be cleaners, insurers, installation companies, florists, packet service providers, etc. These can be actively contacted and remunerated. Example of a digital microtask platform: Amazon Mechanical Turk (https://www.mturk.com/)—mini jobs can be allocated and paid for on this platform.

In some embodiments, an AI/bot service is available. This can guide technologically less well-versed users through the acquisition process, and provide help and guidance in response to any questions. Furthermore, an additional communication channel can be set up, in order to provide user support. For example, explicit requests can be made or help provided by means of a video feed (on both sides). If a positioning infrastructure is available, be it satellite (GPS etc.) outside a building, radio (Bluetooth beacons etc.) or other positioning technology (e.g. image fingerprinting, magnetic field, QR code), jobs can also be explicitly offered or allocated to persons in the vicinity of a known deployment location.

A report of damage can be submitted in a diversity of ways: telephone, e-mail, other type of electronic message, Website, and also App. Photos, videos or also sounds recorded serve in such cases to better explain the damage or the state. A service technician or facility manager etc. commissioned if necessary thus has more details about the extent of the damage and the necessary materials for repairing the damage. In addition, the service technician can be directed by navigation safely and without any diversions to the deployment location.

In some embodiments, systems and objects that are subject to a (possibly legislation-related, regular) visual check, can be acquired digitally with the aid of the App mentioned (and also Web service, etc.). As well as the OK or FALSE, the location data and the precise time of day are also acquired by a positioning system in the log. Photos, videos, sound, or spoken comments can be obtained before the conclusion of the visual check, but also, in the event of problems, help in better understanding said problems from a remote location at a later stage. Corresponding analysis algorithms can in such cases also determine whether the correct object is involved. The data is stored directly in a database or the Cloud and is thus available to the client as evidence that the work has been done or also for statistical analysis. The completion of the visual check is then also confirmed by the App/service and transferred to the backend (e.g. ERP system (SAP) for invoicing).

Clients can however also carry out the visual check at the intervals planned by them, if for example a visit is paid to the installation for some other reason. The time window of the checking interval will then be set to zero again.

The service App or the Web service can also activate or also control an autonomous robot (aerial (drone) or ground-based) and thus expand the area of deployment: e.g. for a facade inspection (invisible (e.g. infrared) or visible wavelengths).

The described methods for creating and/or for maintaining a database with data from devices installed in a building and/or with data from devices installed on a site may provide the following advantages:
In all areas the App or the Web service, through the acquisition of data, ensures more information and thus greater transparency. The resulting information derived ensures more efficiency and thus offers an ecological and economic benefit. Furthermore, by using the crowd, a price advantage compared to an on-site skilled, highly-qualified (=high hourly rate) technician can be achieved. To guarantee a high level of quality for a visual check, a multi-person approach can also be optionally adopted: instead of just obtaining feedback from one person for a product, with (specifically safety-relevant) products it can be worth recommending obtaining several “opinions”, that is to say having a number of checks made. A better quality is thus obtained by quantitative measures.
The acquisition of the environment data and the multimedia information enhancement (photo, video, voice), which is possible through explicit deployment of personnel or also through any smartphone user (or user of any other similar terminal/wearable/implant), contribute to improving the quality of the data. The inclusion of environment information produces a better overall context for the products used.
The App can be downloaded from the appropriate App store, via an NFC tag or via a QR code link, and installed on the smartphone. A corresponding Web service can be called up by calling it in a corresponding program. As an alternative, an “intelligent assistant” (bot; AI) can also forward the acquired data to the backend responsible for it.
By determining the position, the assignment to the corresponding fire alarm center or to the corresponding fire detection zone is possible. Furthermore, through such information other products acquired in such a detection zone can also be assigned to a defined zone.
The iBase will be successively expanded with old installations and this makes it possible to explicitly market migration concepts to the client. Generally, the service may be optimized, which leads to a cost saving. This increases the margin or the competitiveness where there is increased pressure on margins.

### LIST OF REFERENCE CHARACTERS

SAT Positioning system
B1, B2 User
MG1, MG2 Mobile device
C Cloud
WS Web service
VE Processing facility
DB Database
GB1, GB2 Building
KV1, KV2 Communication link
C1, C2 Controller
FG1-FG3 Field device
L1, L2 Light
BM1, BM2 Fire detector
H Heating
QR QR code
A Job
MA Mini job
GD Device data
AG Client
VS1-VS3 Method step

1. A method for maintaining a database with data associate with a plurality of devices present at a site, the method comprising:
establishing a connection to a Web service via a software program installed on a mobile communication terminal;
sending data acquired by a user using the mobile communication terminal to the Web service; and
entering the data received from the mobile communication terminal into the database by a corresponding database entry.

2. The method as claimed in claim 1, further comprising instructing the user by the Web service via the mobile communication terminal to take a photograph or to make a video recording of one of the plurality of devices and transmit the data to the Web service.

3. The method as claimed in claim 2, further comprising instructing the user a mini job via the mobile communication terminal.

4. The method as claimed in claim 1, further comprising, based on the local position of the mobile communication terminal, instructing the user of the mobile communication terminal by the Web service to take a photograph or to make a video recording of one of the plurality of devices located in the environment of the mobile communication terminal and transmit them to the Web service.

5. The method as claimed in claim 1, further comprising visually checking one or more of the plurality of devices.

6. The method as claimed in claim 1, wherein the data sent to the Web server comprises at least one of the group consisting of: text, an image, a video, audio information, a time of day, location data, and sensor information.

7. A system for maintaining a database with data associated with a plurality of devices present at a site, the system comprising:
a mobile communication terminal with a corresponding software program for providing a connection to a Web service; and
a server on which the Web service and the database are implemented;
wherein data acquired by a user using the mobile communication terminal is sent to the Web service;
the Web service enters the data received from the mobile communication terminal into the database using a corresponding database entry.

8. The system as claimed in claim 7, further comprising a facility for determining the location of the mobile communication terminal;
wherein, based on the local position of the mobile communication terminal, the user of the mobile communication terminal is instructed by the Web service to take a photograph or a video recording of one of the plurality of devices near the mobile communication terminal and transmit the data to the Web service.

9. The system as claimed in claim 7, wherein:
the mobile communication terminal is configured to receive mini jobs; and
the user is instructed by a mini job via the mobile communication terminal to take a photograph or a video recording of one of the devices of the plurality of devices and transmit associated data to the Web service.
